(19) United States
(12) Patent Application Publication
(10) Pub. No.: US 2007/0156420 A1
(43) Pub. Date: Jul. 5, 2007

(54) Performance modeling and the application life cycle

(75) Inventors: John D. Meier, Bellevue, WA (US); Rico Mariani, Kirkland, WA (US); Srinath Vasireddy, Issaquah, WA (US); Ashish Babbar, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/321,818

(22) Filed: Dec. 29, 2005

(51) Int. Cl. G06Q 99/00

(52) U.S. Cl. 705/1

(57) ABSTRACT

End-to-end guidance for managing performance and scalability throughout the application life cycle to reduce risk and lower total cost of ownership is provided. In one aspect, the novel innovation provides a framework that organizes performance into prioritized categories where choices can impact performance and scalability success. The logical units of the framework can help integrate performance throughout the application life cycle. The information assessed by the innovation can be segmented by roles, including architects, developers, testers, and administrators, to make it more relevant and actionable. The innovation can provide processes and actionable steps for modeling performance, measuring, testing, and tuning of applications.

### BACKGROUND

Analysis of software systems has proven to be extremely useful to development requirements and to the design of systems. As such, it can be particularly advantageous to incorporate performance analysis into the software development life cycle from the beginning stage of design. Recently, there has been a growing trend to incorporate performance analysis into the software specification. However, these conventional systems lack accuracy and ease of implementation.

Today, when developing an application, it is oftentimes difficult to predict how the application will react under real-world conditions. In other words, it is difficult to predict the performance of an application prior to and during development and/or before completion. Frequently, upon completion, a developer will have to modify the application in order to adhere to real-world conditions. This modification can consume many hours of programming time and delay application deployment—each of which is very expensive.

By way of example, it is often difficult for a programmer to predict operational performance of an application without knowing specific operating environment criterion. In one example, applications often react differently if utilized by a single user as when utilized by a multitude of users. More particularly, the response time of an application is most often decreased upon a multi-user load as opposed to a single user load. Similarly, processor performance reacts differently upon different operating conditions. These and other criteria greatly affect the performance of an application.

While many of these criterions can be estimated with some crude level of certainty, others cannot. For those criterions that can be estimated prior to development, this estimate most often requires a great amount of research and guesswork in order to most accurately determine the criterion. The conventional guesswork approach of performance prediction is not based upon any founded benchmark. As well, these conventional approaches are not systematic in any way. In other words, conventional systems do not enable repetitive testing and/or validation when accessing performance within the application life cycle.

In accordance with traditional application life cycle development, it is currently not possible to proactively (and accurately) address performance issues from the beginning to the end of the life cycle. To the contrary, developers often find themselves addressing performance issues after the fact—after development is complete. This retroactive performance modeling approach is extremely costly and time consuming to the application life cycle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises end-to-end guidance for managing performance and scalability throughout the application life cycle to reduce risk and lower total cost of ownership. In one aspect, the novel innovation provides a framework that organizes performance into prioritized categories where choices can impact performance and scalability success. The logical units of the framework can help integrate performance throughout the application life cycle.

In a particular aspect of the innovation, information can be segmented by roles, including architects, developers, testers, and administrators, to make it more relevant and actionable. The innovation can provide processes and actionable steps for modeling performance, measuring, testing, and tuning of applications.

In specific aspects, expert guidance can also be provided for improving the performance of managed code, ASP.NET, enterprise services, web services, remoting, ADO.NET, extensible markup language (XML), and SQL server.

In still another aspect of the subject innovation, performance objectives can be employed to enable assessment of an application with respect to predefined (and/or dynamically changing) performance goals. Performance modeling can be employed to provide a structured and repeatable approach to meeting the performance objectives. Performance modeling can help assess design choices before committing to a solution. By considering performance objectives, workload, and metrics for scenarios at the onset of development, risk can be reduced and likewise efficiency enhanced by making informed choices.

Moreover, architecture and design guidelines can enable engineering for performance from an early stage rather than encountering a situation where retroactive (e.g., post-development) configuration and modification is necessary. A performance and scalability frame enables the organization and/or prioritization of performance issues. Still another aspect is directed to a system of measuring that assists in determining whether an application is trending toward or away from the performance objectives.

In yet another aspect thereof, an artificial intelligence (AI) component can be provided that employs a probabilistic and/or statistical-based analysis to prognose or infer an action that a user desires to be automatically performed. For example, the AI component can be employed to automatically define performance objectives and/or retroactive tuning based at least in part upon a user preference.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates performance modeling in accordance with an aspect of the innovation.

FIG. 2 illustrates a system that performs multiple acts in accordance with a novel performance modeling system.

FIG. 3 illustrates an exemplary performance modeling component having multiple components therein which facilitate performance modeling in accordance with the novel innovation.

FIG. 4 illustrates an exemplary flow chart of procedures that facilitate performance modeling in accordance with an aspect of the innovation.

FIG. 5 illustrates an exemplary flow chart of procedures that facilitate identifying key scenarios in accordance with an aspect of the innovation.

FIG. 6 illustrates an exemplary flow chart of procedures that facilitate identifying a workload in accordance with an aspect of the innovation.

FIG. 7 illustrates an exemplary flow chart of procedures that facilitate identifying performance objectives in accordance with an aspect of the innovation.

FIG. 8 illustrates an exemplary flow chart of procedures that facilitate identifying a budget in accordance with an aspect of the innovation.

FIG. 9 illustrates an exemplary flow chart of procedures that facilitate identifying processing steps in accordance with an aspect of the innovation.

FIG. 10 illustrates an exemplary flow chart of procedures that facilitate allocating a budget in accordance with an aspect of the innovation.

FIG. 11 illustrates an exemplary flow chart of procedures that facilitate evaluation of the performance modeling in accordance with an aspect of the innovation.

FIG. 12 illustrates an exemplary flow chart of procedures that facilitate validation of the performance modeling in accordance with an aspect of the innovation.

FIG. 13 illustrates an exemplary overall performance engineering system with respect to the application life cycle and in accordance with an aspect of the novel innovation.

FIG. 14 illustrates an exemplary performance design inspection system in accordance with an aspect of the innovation.

FIG. 15 illustrates an exemplary flow chart of procedures that facilitate load testing in accordance with an aspect of the innovation.

FIG. 16 illustrates an exemplary flow chart of procedures that facilitate performance tuning in accordance with an aspect of the innovation.

FIG. 17 illustrates an architecture including an artificial intelligence-based component that can automate functionality in accordance with an aspect of the novel innovation.

FIG. 18 illustrates a block diagram of a computer operable to execute the disclosed architecture.

FIG. 19 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

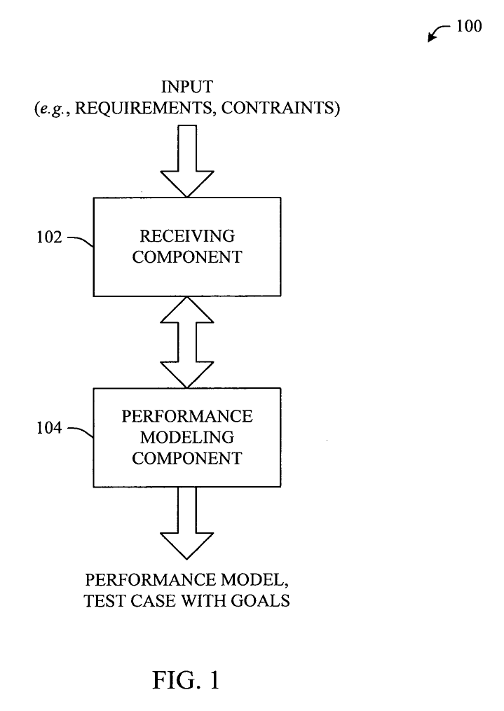

Referring initially to the drawings, FIG. 1 illustrates a performance engineering system 100 in accordance with an aspect of the innovation. Generally, the system 100 can include a receiving component 102 and a performance modeling component 104. The receiving component 102 can accept an input including, but not limited to, application constraints, requirements, etc. Accordingly, the performance modeling component can establish a performance model, test cases with goals, etc. from the input. This generated output can facilitate proactive performance modeling throughout the application life cycle.

As stated previously, conventionally, performance and scalability are often treated at the end of the application life cycle where the problem cannot be fixed. To this end, the novel system 100 can facilitate proactively engineering and modeling throughout the application life cycle. This proactive engineering and modeling can help identify how to balance performance against the other quality attributes such as security. As well, the novel system 100 can facilitate integration of performance into the design and throughout the application life cycle.

Effectively, the system 100 can bake performance into the application life cycle. In doing so, the novel system 100 can overlay a set of specific activities that can be proven empirically to address performance issues. Accordingly, a user can systematically achieve pre-engineered performance objectives. In one particular aspect, the novel innovation can facilitate integration of the performance engineering approach into Visual Studio-brand and .NET/MSF Agile-brand environments.

In another particular aspect, the novel innovation can facilitate security integration in the application life cycle by identifying a set of proven security focused activities. These security focused activities can be integrated into the application life cycle thereby enhancing ability to meet security objectives.

As stated supra, the subject novel innovation can bake performance into the application life cycle. In operation, performance focus can be added to common activities. In aspects, the novel innovation can add performance focus in the design guidelines for performance, architecture and design review for performance, code review for performance, deployment review for performance, etc.

All in all, the system 100 can facilitate proactively adding performance modeling up front to identify security objectives and shape application design. In doing so, the innovation can employ scenario-based and type-specific (e.g., web application, desktop application) guidance.

In addition to modeling performance, the subject innovation can facilitate managing risk with respect to an application's performance. As well, the innovation facilitates systematic design for performance (e.g., where to start, how to proceed, when to finish). This novel yet proven approach can facilitate identification of constraints/boundaries for success (e.g., test case) and systematic incorporation of performance principles, practices, patterns and anti-patterns into the application life cycle.

As shown in FIG. 1, receiving component 102 can obtain a number of inputs that can be used in the performance modeling process (e.g., via performance modeling component 104). Following are descriptions of some exemplary inputs. It is to be understood and appreciated that these inputs are provided to add context to the innovation and are not intended to limit the scope of this disclosure in any way. Moreover, it is to be understood that additional inputs can employed in accordance with the novel functionality described herein. These additional aspects are to be included within the scope of this disclosure and claims appended hereto.

In accordance with disparate aspects, these inputs can include initial (and/or tentative) information about the following:

Scenarios and design documentation about critical and significant use cases;

Application design and target infrastructure as well as any constraints imposed by the infrastructure;

Quality of Service (QoS) requirements and infrastructure constraints, including service level agreements (SLAs); and

Workload requirements derived from marketing data associated with prospective customers.

The output from performance modeling can be a performance modeling document as well as test cases with goals. The performance model can address performance objectives, budgets, workloads, itemized scenarios with goal and test cases with goals. An itemized scenario is a scenario that is broken down into processing steps. For example, an order scenario might include authentication, order input validation, business rules validation, and orders being committed to the database. The itemized scenarios can include assigned budgets and performance objectives for each step in the scenario.

With respect to test cases, these test cases can be employed to generate performance metrics. The test cases can validate an application against performance objectives. Test cases can help a user determine whether a trend is toward or away from performance objectives. Generation of these outputs will be better understood upon a review of the figures that follow.

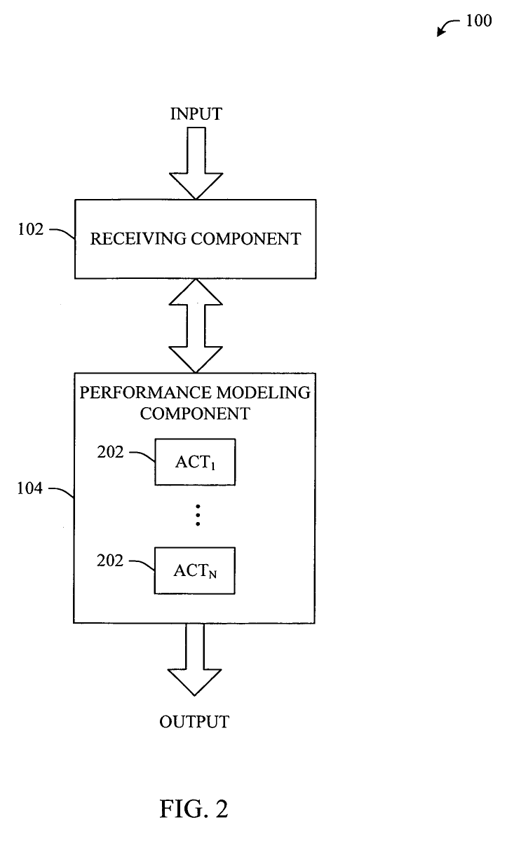

FIG. 2 illustrates an alternative block diagram of the performance modeling component 104. As shown, the modeling component can include 1 to N act components. It is to be understood that 1 to N act component can be referred to individually or collectively as act components 202. Although the following scenarios illustrate specific acts inclusive to the performance modeling component 104, it is to be understood that a subset of the illustrated acts can be employed to facilitate the novel performance modeling activity.

Moreover, it is to be understood that performance modeling component 104 is illustrative of just one baseline of novel performance activities. By way of example, other activities can include, but are not limited to, generation of performance objectives, performance design inspections, performance code inspections and performance testing. In accordance therewith, artifacts (e.g., outputs) can be produced such as performance specifications, performance models, performance design guidelines, performance design inspection gates, performance code inspection gates and performance release templates.

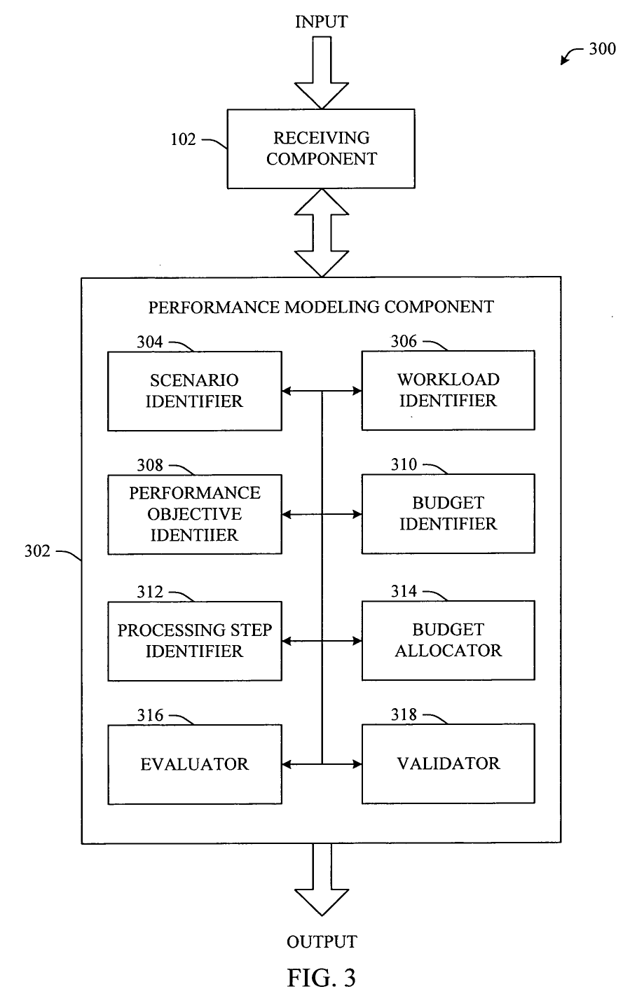

FIG. 3 illustrates a system 300 that includes a specific performance modeling component 302 in accordance with an aspect of the innovation. As shown, the performance modeling component 302 can include a scenario identifier 304, a workload identifier 306, a performance objective identifier 308, a budget identifier 310, processing step identifier 312, a budget allocator 314, an evaluator 316 and a validator 318. An exemplary process of the performance modeling component 104 is illustrated in the figures that follow.

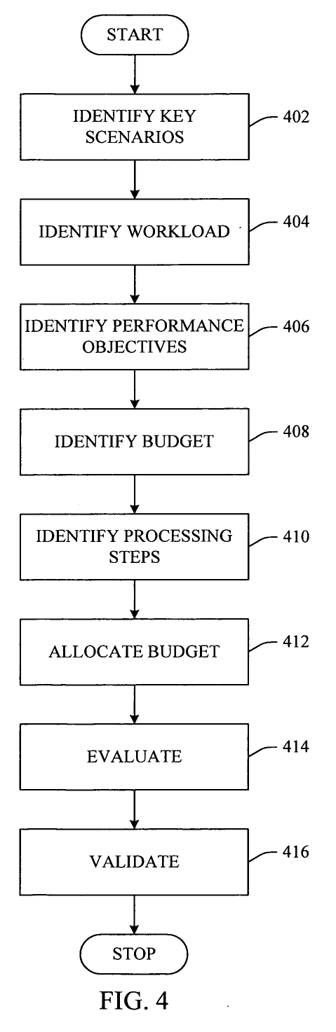

FIG. 4 illustrates a methodology of performance modeling methodology in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 4 illustrates an eight step performance model in accordance with an aspect of the novel innovation. At 402, key scenarios can be identified. More particularly, scenarios where performance is particularly important and scenarios that pose the most risk to performance objectives can be automatically and/or dynamically identified. At 404, an applicable workload can be determined. In other words, at 404 a number of users and/or concurrent users that the system will have to support are identified.

At 406, performance objectives can be identified. For example, performance objectives for each of the key scenarios can be identified. In one particular aspect, performance objectives can reflect specific business requirements.

A budget, limitation and/or constraint can be identified at 408. In one particular example, this act can include the maximum execution time in which an operation is to be completed. In another example, this act can include an identification of resource utilization constraints, such as CPU, memory, disk I/O, network I/O, etc.

At 410, processing steps in accordance with each of the key scenarios can be identified. In other words, key scenarios can be parsed into disparate component processing steps. The budget can be allocated at 412. In this act, the total budget determined in act 408 can be allocated across the processing steps established in act 410. More particularly, this allocation can be made in order to meet the performance objectives set forth in act 406.

Once the budget is allocated at 412, the design can be evaluated at 414. In other words, the design can be evaluated against the pre-defined objectives and/or budget. You may need to modify the design or spread response time and resource utilization budget differently to meet the performance objectives.

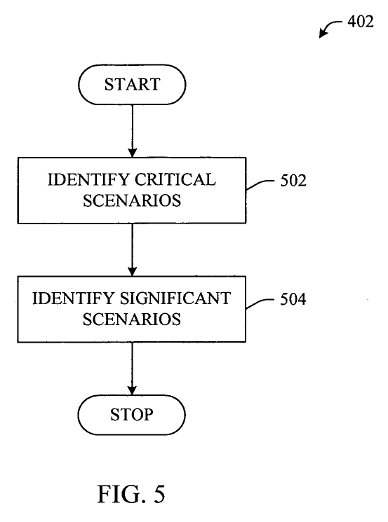

The model can be validated at 416—by way of example, the pre-defined examples can be validated at 416. As will be better understood upon a review of the figures and/or methodologies that follow, this validation act can be an ongoing activity throughout the application life cycle. As well, the validation of 416 can include prototyping, assessing, and measuring in accordance with objectives and/or budget. Each of the preceding acts will be described in greater detail below with reference to FIGS. 5-12 that follow.

FIG. 5 illustrates a detailed methodology of act 402 described supra. More specifically, methodology 402 illustrates acts that can be employed in identifying key scenarios. In this act, application scenarios that are important from a performance perspective can be identified. It is to be understood that if documented use cases or user stories are available, this documented information can be employed in defining the key scenarios. The identification of key scenarios can include an identification of critical scenarios (502) and/or an identification of significant scenarios (504).

Referring first to the act of identifying critical scenario, at 502, these can be the scenarios that share specific performance expectations or requirements. By way of example, these scenarios can be those covered by service level agreements (SLAs) or those that have specific performance objectives. It is to be understood that critical scenarios can include additional scenarios deemed “critical.” These additional scenarios are to be included with the scope of this disclosure and claims appended hereto.

Turning now to a discussion of significant scenarios, at 504, significant scenarios can be identified. These significant scenarios do not have specific performance objectives such as a response time goal, but rather, may impact other critical scenarios. In one particular example, to assist in the identification of significant scenarios, the following characteristics can be employed:

Scenarios that run in parallel to a performance-critical scenario;

Scenarios that are frequently executed;

Scenarios that account for a high percentage of system use; and

Scenarios that consume significant system resources.

It will be appreciated that significant scenarios are particularly important and should not be overlooked. It will further be appreciated that significant scenarios can influence whether critical scenarios meet their performance objectives. Moreover, it is particularly important to consider how the system will react if different significant or critical scenarios are being run concurrently by disparate users. This “parallel integration” often drives key decisions about an application's units of work. For example, in order to keep search response brisk, it can be useful to commit orders one line item at a time.

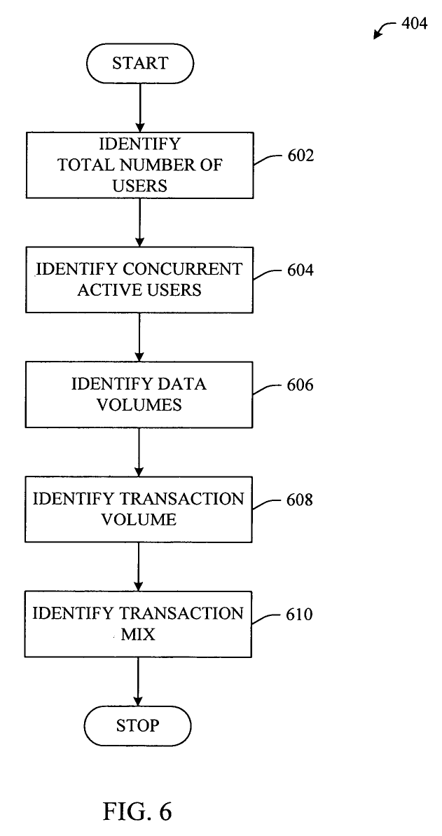

Referring now to a discussion of the identification of a workload—FIG. 6 illustrates a methodology 404 of identifying a workload in accordance with an application life cycle. In one aspect, the workload can be derived from marketing data. In accordance therewith, the workload can be established by identifying a total number of users at 602 and a total number of concurrent active users 604.

At 606, data volumes can be identified in accordance with identifying a workload. Similarly, transaction volumes and a transaction mix car be identified at 608 and 610 respectively.

In accordance with performance modeling, it is particularly useful to identify how this workload applies to an individual scenario. By way of more specific example, the workload can be applied to a scenario where 100 concurrent users will be supported in browsing. Similarly, in another disparate aspect, the workload can be applied to a scenario where 10 concurrent users can be supported in placing orders. It is to be understood and appreciated that concurrent users are those users that access a web site at exactly the same moment. On the other hand, simultaneous users refer to those users who have active connections to the same site.

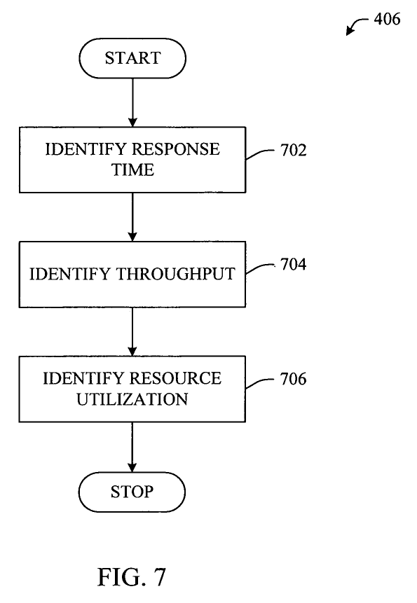

Turning now to FIG. 7, a methodology 406 of identifying performance objectives is shown. For each scenario identified via the methodology 404 above, performance objectives can be identified. In one aspect, the performance objectives can be determined in accordance with business requirements. As shown in FIG. 7, performance objectives can refer to identifying response time (702), throughput (704) and resource utilization (706).

With respect to identifying response time, at 702, in one aspect of the innovation, a product catalog must be displayed in less than 3 seconds. While this as well as the examples that follow include specific criterion, it is to be understood that these examples are included to provide context to the invention. As such, these examples are not intended to be limiting in any way.

As shown, throughput can be identified at 704. By way of specific example, in one aspect of the innovation, the system must support 100 transactions per second. Similarly, resource utilization can be identified at 706. It will be understood that conventional approaches frequently overlook how much of a resource an application consumes. As such, resource utilization can be represented in terms of CPU, memory, disk I/O, network I/O or the like.

In accordance with aspects of the innovation, the following can be considered when establishing performance objectives:

Workload requirements;

SLAs;

Response times;

Projected growth; and

Lifetime of the application.

For projected growth, in one aspect, it can be useful to consider whether the application design will meet needs in six months or a year in the future. If the application has a lifetime of only six months it can be useful to decide to trade some extensibility for performance. Similarly, if the application is likely to have a long lifetime, it can be useful to decide what performance can be traded for maintainability.

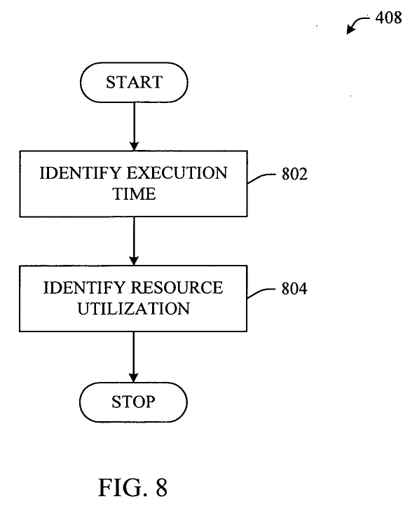

FIG. 8 illustrates a methodology 408 for identifying a budget in accordance with an aspect of the innovation. As described supra, it is to be understood that budgets are the constraints. For example, in one aspect, a budget can define the longest acceptable amount of time that an operation should take to complete, beyond which the application fails to meet its performance objectives.

In accordance with a specific aspect and as illustrated in FIG. 8, the budget can be specified in terms of execution time (802) and resource utilization (804). In accordance with identifying a budget, at 802, the execution time can be identified. More particularly, the execution time can identify the maximum amount of time that a particular operation can take to perform.

At 804, resource utilization requirements can be identified in accordance with specific aspects of the innovation. Resource utilization requirements can define the threshold utilization levels for available resources. By way of example, in one aspect, there may be a peak processor utilization limit of 75 percent and memory consumption limit of 50 MB. In alternative examples, all aspects of resource utilization can be considered, including, but not limited to CPU, memory, network I/O, disk 1/O, etc.

Additional considerations that can be helpful in the context of the performance objectives can include execution time and resource utilization. It is to be understood that budget can have several other dimensions. For example, other considerations for budget can include the following:

Network—e.g., network considerations such as bandwidth;

Hardware—e.g., hardware considerations such as servers, memory, and CPUs;

Resource dependency—e.g., resource dependency considerations such as the number of available database connections and web service connections;

Shared resources—e.g., shared resource considerations such as the amount of bandwidth available, the amount of CPU if a server is shared with other applications, and the amount of memory available; and

Project resources—e.g., from a project perspective, budget can also be a constraint, such as time and cost.

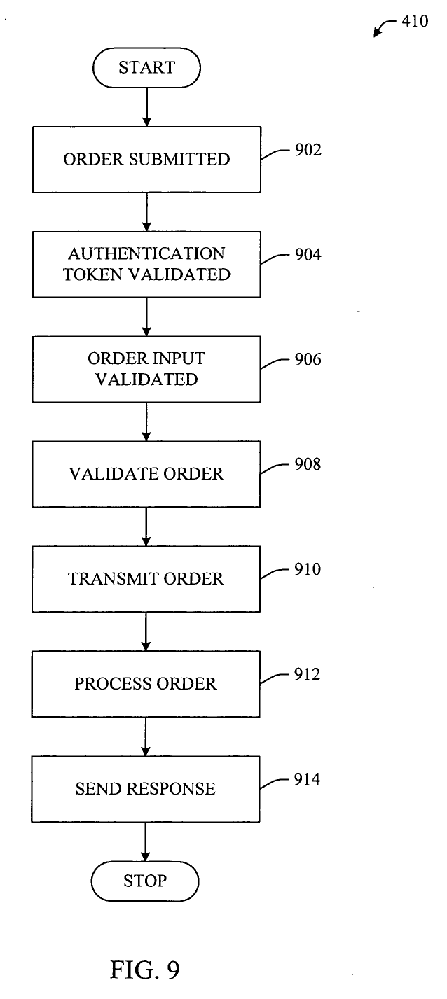

FIG. 9 illustrates a methodology 410 of identifying processing steps in accordance with an aspect of the novel innovation. In order to identify processing steps, the scenarios can be itemized and divided into the individual processing steps. FIG. 9 illustrates an exemplary methodology 410 in accordance with an aspect of the innovation. It will be appreciated by those skilled in the art that use cases and sequence diagrams can be used as input.

In accordance with a particular embodiment, at 902 an order can be submitted by a client. The client authentication token can be validated at 904. Accordingly, at 906, an order input can be validated. In one aspect and as set forth in act 908, business rules can be employed to validate the order. Once validated, at 910, the order can be transmitted to a database server for processing at 912. Following processing of the order, a response can be sent to the client at 914.

It is to be understood that an added benefit of identifying processing steps is that the processing steps can assist in identifying points within the application which should be considered in terms of adding custom instrumentation. Instrumentation that can be particularly advantageous to provide actual costs and timings testing of the application is commenced.

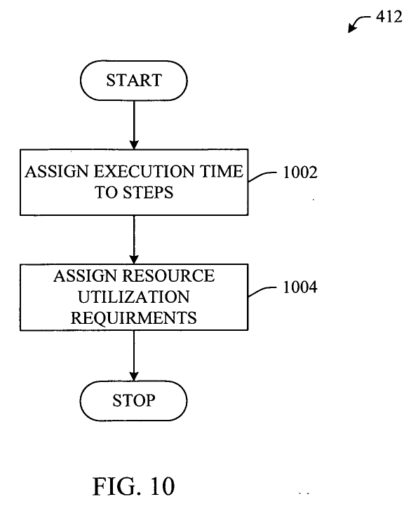

FIG. 10 illustrates a methodology 412 of allocating budget in accordance with an aspect of the innovation. In other words, this methodology 412 can facilitate spreading the budget across the identified processing steps in order to meet performance objectives. In accordance with the example described supra, it will be appreciated that execution time (1002) and resource utilization (1004) can be considered.

With reference first to the act of assigning execution time to processing acts, at 1002, when assigning time to processing acts, if specific time intervals are not known, the total time can be equally between the processing steps. Because the budget will be reassessed as described below, it is not imperative for the values to be precise at this stage. Rather, the budget can be reassessed after measuring actual processing time. However, it is to be understood that it is particularly important to have an idea of the values.

Even though actual values will be determined within the evaluation stage described below, it is particularly important not to want to wait until the application is built and instrumented to get real numbers. As described above, where execution times are not known, it can be particularly useful to try spreading the time evenly. Moreover, it can be useful to identify where there might be problems or where there might be tension.

If dividing the budget illustrates that each step has ample time, there is no need to examine these further. However, for those that are questionable, it can be particularly important to conduct some experiments (for example, with prototypes) to verify that what is projected is possible prior to proceeding.

It is to be understood that one or more of the steps can have a fixed time. For example, it can be possible to determine that making a database call not complete in less than 3 seconds. Other times are variable. The fixed and variable costs are to be less than or equal to the allocated budget for the scenario.

Next, at 1004, resource utilization requirements can be assigned. When assigning resources to processing steps, there are a number of scenarios that can be considered. In one example, it can be useful to know the cost of materials. By way of example, it is useful to know the cost of technology X in comparison to technology Y. In another aspect, it can be useful to know the budget allocation for hardware. In other words, it is useful to define the total resources available.

In still other aspects, it is advantageous to know the hardware systems that are already in place. Additionally, it is useful to be intimately aware of the application functionality. For example, heavy extensible markup language (XML) document processing can require more CPU, chatty database access or web service communication may require more network bandwidth, or large file uploads may require more disk I/O. Each of these scenarios can affect the resource utilization requirement assignments.

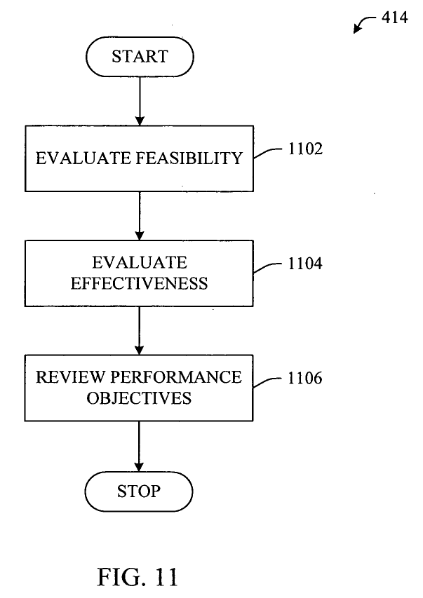

FIG. 11 illustrates a methodology 414 of evaluating the performance model in accordance with an aspect of the innovation. At 1102 and 1104 respectively, the feasibility and effectiveness of the budget can assessed. As described above, this evaluation can enhance efficiency by performing prior to expending time and effort on prototyping and testing. At 1106, a review the performance objectives can be conducted. In doing so, the following list of exemplary issues can be considered:

Does the budget meet the objectives?

Is the budget realistic?

Does the model identify a resource hot spot?

Are there more efficient alternatives?

Can the design or features be reduced or modified to meet the objectives?

Can efficiency be improved in terms of resource consumption or time?

Would an alternative pattern, design, or deployment topology provide a better solution?

What is the trade-off? e.g., is the system trading productivity, scalability, maintainability, or security for performance?

In accordance with the answers to the above questions, the following actions can be considered in an effort to enhance efficiency:

Modification of the design;

Reevaluation of requirements; and

Change the way budget is allocated.

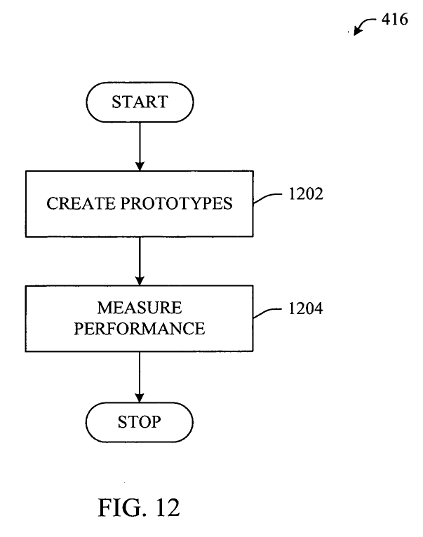

FIG. 12 illustrates a methodology 416 of validating the performance model in accordance with an aspect of the innovation. At 1202, prototypes can be created and thereafter, performance can be measured at 1204. The performance can be measured in accordance with the use cases by capturing metrics. It will be appreciated that this validation methodology 416 is an ongoing activity that includes prototyping and measuring. In operation, validation can be continued until the performance goals are met. It will be appreciated that the further into the project life cycle, the greater the accuracy of the validation. Early on, validation can be based on available benchmarks and prototype code, or sometimes just proof-of-concept code. Later, the actual code can be measured as the application develops.

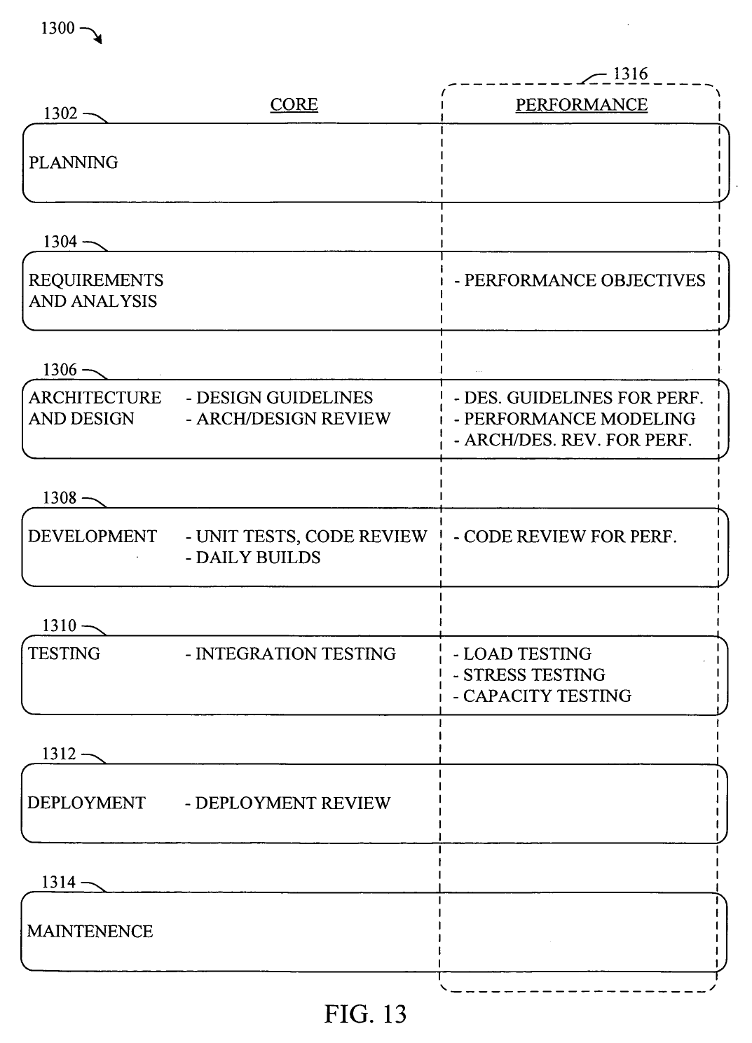

As stated earlier, the preceding example has been a detailed discussion of the novel performance modeling techniques of the subject innovation. Illustrated in FIG. 13 is an overall view of an exemplary performance engineering system 1300. Generally, this system 1300 can include a planning component 1302, a requirements and analysis component 1304, an architecture and design component 1306, a development component 1308, a testing component 1310, a deployment component 1312 and a maintenance component 1314. As shown in FIG. 13, the aforementioned performance modeling technique is inclusive of the architecture and design component 1306 of exemplary system 1300.

Performance aspects of the overall engineering model are identified by the dashed line 1316. More particularly, as described supra, performance objectives can be established as a part of a requirements and analysis phase. The design guidelines for performance, performance modeling and architecture/design review for performance are inclusive of the architecture and design phase 1306 of system 1300. In the development phase 1308, a code review for performance can be effectuated. Finally, load testing, stress testing and capacity testing can be effectuated in the testing phase 1310.

As illustrated in FIG. 13, sample components for the engineering techniques are shown. More particularly, system 1300 of FIG. 13 can include exemplary performance modeling, performance design inspection, load testing, stress testing and performance tuning components. As the novel performance modeling technique has been described in detail above, the other exemplary components will be described below. These exemplary components are to be included within the scope of this disclosure and claims appended hereto.

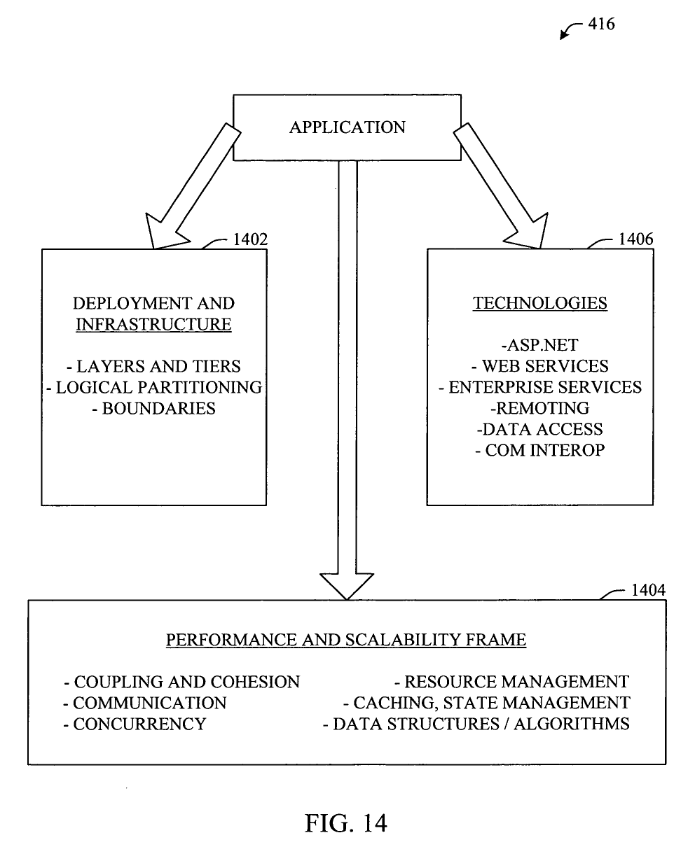

With respect to the performance design inspection (e.g., 1306), FIG. 14 illustrates an exemplary performance design inspection phase. More particularly, at 1402, deployment and infrastructure can be addresses. More particularly, a review of the application in relation to a target deployment environment can be effected. Additionally, a review of any associated restrictions can be completed.

At 1404, performance and scalability frame can be addressed. Here it is particularly important to pay attention to the design approaches adopted for those areas that most commonly exhibit performance bottlenecks. These areas will be understood by those skilled in the art.

Additionally, at 1406, a layer by layer analysis of the application can be effected. In this phase, a walk through of the logical layers of the application can be completed. Accordingly, performance characteristics of the various technologies employed within each layer can be examined.

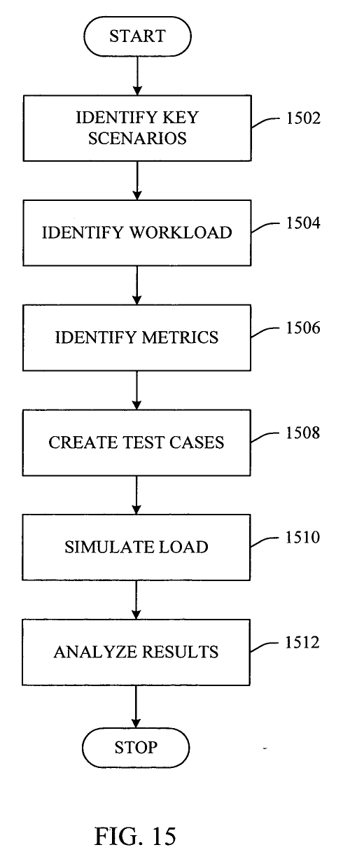

FIG. 15 illustrates a methodology of load testing in accordance with the novel life cycle performance engineering aspects of the innovation. At 1502, key scenarios can be identified. These key scenarios can be described as application scenarios that are critical to the performance of the application. Next, the workload can be identified at 1504. In doing so, the total application load can be distributed among the key scenarios identified in 1502.

Metrics can be identified at 1506 in accordance with the load testing methodology. In accordance therewith, metrics can be identified that represent desired performance criterion when conducting the test. At 1508, test cases can be created whereby steps for conducting a single test along with the expected results can be defined.

The load can be simulated in accordance with the test cases at 1510. In this act, the resulting metric data can be captured. Finally, the results can be analyzed at 1512. More particularly, the metric data captured during the test can be analyzed. It will be appreciated that similar acts can be performed in connection with stress testing. These acts will be understood by those skilled in the art and are to be included within the scope of this disclosure and claims appended hereto.

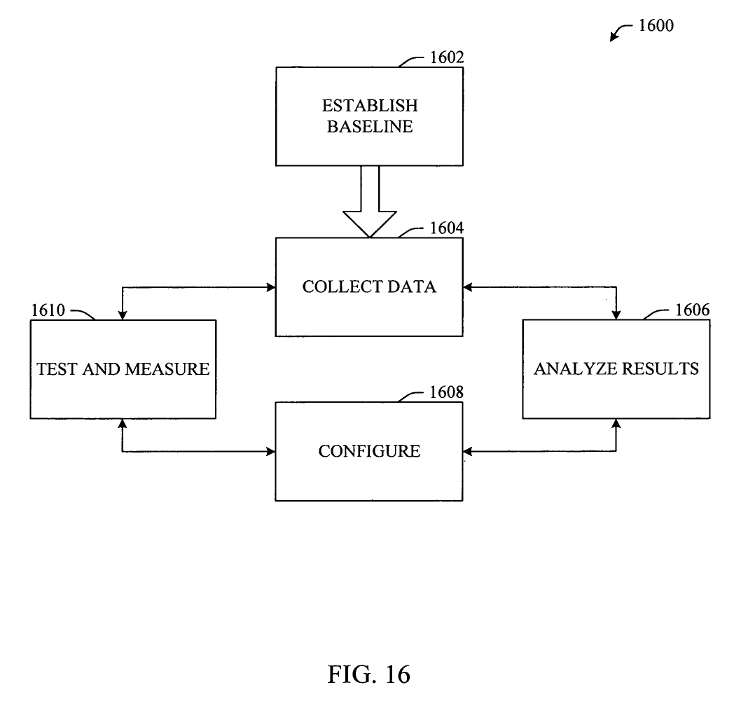

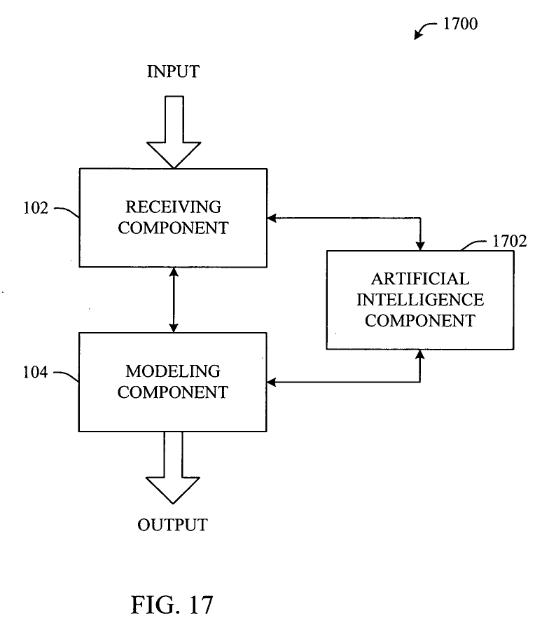

Turning now to FIG. 16, a performance tuning methodology 1600 is shown in accordance with an aspect of the innovation. More particularly, at 1602, a baseline can be established. In other words, at 1602, a well-defined set of performance objectives, test plans, baseline metrics, etc. can be established. As will be better understood upon a review of FIG. 17 that follows, in one aspect, this establishment of a baseline can be effectuated via artificial intelligence (AI) or machine learning.

At 1604, the load and capture metrics can be simulated in order to gather information with respect to the application. In the analysis phase, 1606, performance issues and/or bottlenecks can be identified. It will be appreciated that the information gathered at 1604 can be employed to analyze the results.

In the configure phase of 1608, the application setup can be tuned by applying new system platform and/or application configuration settings. Finally, at 1610, tests and additional measurements can be effected in order to verify that configuration changes have been beneficial.

FIG. 17 illustrates a system 1700 that employs Al which facilitates automating one or more features in accordance with the subject innovation. The subject innovation (e.g., setting a baseline, objectives, tolerances, etc.) can employ various Al-based schemes for carrying out various aspects thereof. For example, a process for determining a baseline set of performance objectives can be facilitated via an automatic classifier system and process.

A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria an appropriate set of baseline objectives as well as acceptable thresholds associated therewith.

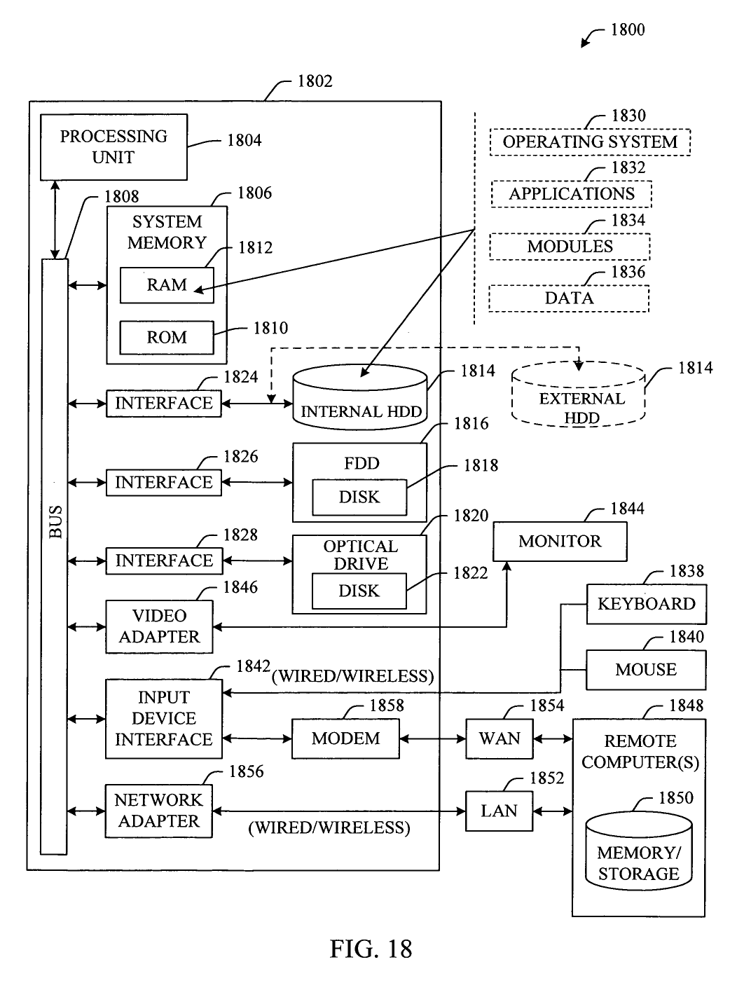

Referring now to FIG. 18, there is illustrated a block diagram of a computer operable to execute the disclosed architecture. In order to provide additional context for various aspects of the subject innovation, FIG. 18 and the following discussion are intended to provide a brief, general description of a suitable computing environment 1800 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 18, the exemplary environment 1800 for implementing various aspects of the innovation includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures may also be employed as the processing unit 1804.

The system bus 1808 can be any of several types of bus structure that may further interconnect to a memory bus (with or without a memory controller), a peripheral bus, and a local bus using any of a variety of commercially available bus architectures. The system memory 1806 includes read-only memory (ROM) 1810 and random access memory (RAM) 1812. A basic input/output system (BIOS) is stored in a non-volatile memory 1810 such as ROM, EPROM, EEPROM, which BIOS contains the basic routines that help to transfer information between elements within the computer 1802, such as during start-up. The RAM 1812 can also include a high-speed RAM such as static RAM for caching data.

The computer 1802 further includes an internal hard disk drive (HDD) 1814 (e.g., EIDE, SATA), which internal hard disk drive 1814 may also be configured for external use in a suitable chassis (not shown), a magnetic floppy disk drive (FDD) 1816, (e.g., to read from or write to a removable diskette 1818) and an optical disk drive 1820, (e.g., reading a CD-ROM disk 1822 or, to read from or write to other high capacity optical media such as the DVD). The hard disk drive 1814, magnetic disk drive 1816 and optical disk drive 1820 can be connected to the system bus 1808 by a hard disk drive interface 1824, a magnetic disk drive interface 1826 and an optical drive interface 1828, respectively. The interface 1824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. It is appreciated that the innovation can be implemented with various commercially available operating systems or combinations of operating systems.

A user can enter commands and information into the computer 1802 through one or more wired/wireless input devices, e.g., a keyboard 1838 and a pointing device, such as a mouse 1840. Other input devices (not shown) may include a microphone, an IR remote control, a joystick, a game pad, a stylus pen, touch screen, or the like. These and other input devices are often connected to the processing unit 1804 through an input device interface 1842 that is coupled to the system bus 1808, but can be connected by other interfaces, such as a parallel port, an IEEE 1394 serial port, a game port, a USB port, an IR interface, etc.

A monitor 1844 or other type of display device is also connected to the system bus 1808 via an interface, such as a video adapter 1846. In addition to the monitor 1844, a computer typically includes other peripheral output devices (not shown), such as speakers, printers, etc.

The computer 1802 may operate in a networked environment using logical connections via wired and/or wireless communications to one or more remote computers, such as a remote computer(s) 1848. The remote computer(s) 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1850 is illustrated. The logical connections depicted include wired/wireless connectivity to a local area network (LAN) 1852 and/or larger networks, e.g., a wide area network (WAN) 1854. Such LAN and WAN networking environments are commonplace in offices and companies, and facilitate enterprise-wide computer networks, such as intranets, all of which may connect to a global communications network, e.g., the Internet.

When used in a LAN networking environment, the computer 1802 is connected to the local network 1852 through a wired and/or wireless communication network interface or adapter 1856. The adapter 1856 may facilitate wired or wireless communication to the LAN 1852, which may also include a wireless access point disposed thereon for communicating with the wireless adapter 1856.

When used in a WAN networking environment, the computer 1802 can include a modem 1858, or is connected to a communications server on the WAN 1854, or has other means for establishing communications over the WAN 1854, such as by way of the Internet. The modem 1858, which can be internal or external and a wired or wireless device, is connected to the system bus 1808 via the serial port interface 1842. In a networked environment, program modules depicted relative to the computer 1802, or portions thereof, can be stored in the remote memory/storage device 1850. It will be appreciated that the network connections shown are exemplary and other means of establishing a communications link between the computers can be used.

The computer 1802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

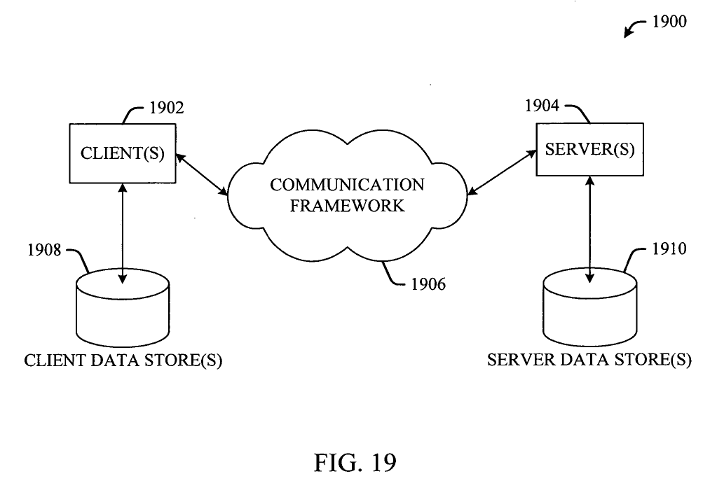

Referring now to FIG. 19, there is illustrated a schematic block diagram of an exemplary computing environment 1900 in accordance with the subject innovation. The system 1900 includes one or more client(s) 1902. The client(s) 1902 can be hardware and/or software (e.g., threads, processes, computing devices). The client(s) 1902 can house cookie(s) and/or associated contextual information by employing the innovation, for example.

The system 1900 also includes one or more server(s) 1904. The server(s) 1904 can also be hardware and/or software (e.g., threads, processes, computing devices). The servers 1904 can house threads to perform transformations by employing the innovation, for example. One possible communication between a client 1902 and a server 1904 can be in the form of a data packet adapted to be transmitted between two or more computer processes. The data packet may include a cookie and/or associated contextual information, for example. The system 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates performance engineering of an application life cycle, comprising:
a receiving component that accepts an input; and
a performance modeling component that generates a performance model of the application life cycle based at least in part upon the input.

2. The system of claim 1, the input is a performance objective based at least in part upon a performance specification.

3. The system of claim 2, the performance modeling component comprises a scenario identifier that establishes a scenario that poses a risk to the performance objective.

4. The system of claim 3, the performance modeling component comprises a workload identifier that identifies a number of users and a number of concurrent users that the system will support.

5. The system of claim 4, the performance modeling component comprises a performance objective identifier that generates the performance objective based at least in part upon each of the established scenario.

6. The system of claim 5, the performance modeling component comprises a budget identifier that identifies a maximum execution time in which an operation is to be completed.

7. The system of claim 6, the budget identifier can determine a resource utilization constraint based at least in part upon one of a CPU, a memory, a disk I/O, and a network I/O.

8. The system of claim 7, the performance modeling component comprises a processing step identifier that parses the scenario into a subset of disparate component processing steps.

9. The system of claim 8, the performance modeling component comprises a budget allocator that allocates the budget to each of the subset of disparate processing steps.

10. The system of claim 9, the performance modeling component comprises an evaluator that evaluates the system based at least in part upon the performance objective and the budget.

11. The system of claim 10, the performance modeling component comprises a validator that confirms the system based at least in part upon an output from the evaluator.

12. The system of claim 1, further comprising an artificial intelligence (AI) component that infers an action that a user desires to be automatically performed.

13. A computer-implemented method of modeling performance of an application, comprising:
identifying a key scenario;
identifying a performance objective based at least in part upon the key scenario; and
identifying a plurality of processing steps based at least in part upon the performance objective.

14. The computer-implemented method of claim 13, further comprising identifying a budget based at least in part upon the performance objective.

15. The computer-implemented method of claim 14, further comprising allocating the budget to a subset of the plurality of processing steps.

16. The computer-implemented method of claim 15, further comprising evaluating the key scenario based at least in part upon the budget.

17. The computer-implemented method of claim 16, the act of evaluating comprises at least one of load testing and stress testing.

18. The computer-implemented method of claim 17, further comprising tuning the application based at least in part upon an output of the act of evaluating.

19. A computer-executable system that facilitates performance modeling of an application, comprising:
computer-implemented means for identifying a key scenario, the key scenario is at least one of a critical and a significant scenario;
computer-implemented means for identifying a workload based at least in part upon the key scenario;
computer-implemented means for establishing a performance objective based at least in part upon one of a response time, a throughput and a resource utilization;
computer-implemented means for identifying a budget based at least in part upon the performance objective; and
computer-implemented means for evaluating performance of the application based at least in part upon the performance objective and the budget.

20. The computer-executable system of claim 19, further comprising:
identifying a plurality of processing steps associated with the performance objective; and
allocating the budget to each of the plurality of processing steps.
